(19) United States
(12) Patent Application Publication
(10) Pub. No.: US 2015/0012181 A1
(43) Pub. Date: Jan. 8, 2015

(54) Vehicle having a plurality of steering programs

(71) Applicant: CLAAS SELBSTFAHRENDE ERNTEMASCHINEN GMBH, HARSEWINKEL (DE)

(72) Inventors: Andreas Brunnert, RIETBERG (DE); DANIEL IRMER, HERZEBROCK-CLARHOLZ (DE); BASTIAN BORMANN, HERZEBROCK-CLARHOLZ (DE)

(21) Appl. No.: 14/314,310

(22) Filed: Jun. 25, 2014

(30) Foreign Application Priority Data
Jul. 4, 2013 (DE) 102013011152.8

(51) Int. Cl. B62D 6/00; B62D 15/02

(52) U.S. Cl. CPC B62D 6/003; B62D 6/001; B62D 15/0265
USPC 701/41

(57) ABSTRACT

An agricultural vehicle has steerable front and rear wheels and a steering control unit for controlling a steering pole of the wheels on a basis of direction-of-travel information. The steering control unit is configured to switch between two or more steering programs that respectively implement different interrelationships between the direction-of-travel information and the steering pole. The steering control unit switches between the two or more steering programs in an event-dependent manner.

### CROSS-REFERENCE TO A RELATED APPLICATION

The invention described and claimed hereinbelow is also described in German Priority Document DE 10 2013 011152.8, filed on Jul. 4, 2013. The German Priority Document, the subject matter of which is incorporated herein by reference, provides the basis for a claim of priority of invention under 35 U.S.C. 119(a)-(d).

### BACKGROUND OF THE INVENTION

The present invention relates to an agricultural vehicle in which front and rear wheels can be steered according to selectable steering programs.

Steered vehicles are known from EP 0 817 741 B1. The European patent document discloses a conventional vehicle with stub-axle steering having a link trapezium on both the front axle and the rear axle. During straight-ahead travel, the stub axles of the front and rear wheels are located on a straight line, which is referred to in this case as the front and rear chassis axis, respectively.

The conventional vehicle supports front steering in particular, i.e. a steering program in which only the front wheels are pivoted, while the stub axles of the rear wheels are unmovable on the rear chassis axis. A steering pole is therefore movable along the rear vehicle axis. A second steering program, in which each of the rear wheels pivots in a direction opposite that of the respective front wheels, delivers a steering pole that is movable along a line extending between the front chassis axis and the rear chassis axis and permits travel around a narrow turning radius.

The selection of a third steering program, in which the front and rear wheels all pivot in the same direction, makes it possible to position the steering pole in the extension of the axis of an attached tool and to thereby limit lateral forces acting between the vehicle and the tool.

In addition, a crab-steering program is supported, in which, during travel straight ahead, all wheels are pivoted by the same predefined angle such that the tracks of all four wheels are offset relative to one another. Driving around curves is made possible in the crab-steering program by setting an angle at the front wheels that differs from the predefined angle.

A driver of this conventional vehicle must remain highly alert and focused in order to select the steering program that is appropriate for the current situation. If an inappropriate steering program is selected, the vehicle is difficult to maneuver and, in the event that a tool is coupled to the vehicle, selecting the wrong steering program can even cause damage to the vehicle or the tool.

### SUMMARY OF THE INVENTION

The present invention overcomes the shortcomings of known arts, such as those mentioned above.

To that end, the present invention provides a vehicle that is flexibly and precisely maneuvered through the use of different steering programs can be utilized, and which do not require greater attention on the part of the driver.

In one embodiment, the invention provides an agricultural vehicle that comprises steerable front and rear wheels and a steering control unit for controlling a steering pole of the wheels on the basis of direction-of-travel information. The steering control unit changes the steering program in an event-dependent manner. The steering control unit is switched between various steering programs that implement different interrelationships between the direction-of-travel information and the steering pole.

The automated switching of the steering program according to the invention depends, in particular, on the movement of the vehicle For example, the arrival of the vehicle at a location is considered, in particular, to be an event that prompts the steering program to be switched.

According to one aspect of the invention, the location is a boundary of a field, e.g., the boundary of a headland or another field having deviating properties. Alternatively, or in addition, the location is the surroundings of a fixed or moving obstacle. In this case, a steering program that differs from the steering program used outside of the surroundings is more suitable in order to avoid contacting the obstacle or to precisely guide the vehicle with a desired separation from the obstacle.

A camera and/or a satellite navigation device and/or a V2V wireless interface are used as means for detecting an event that induces a switch in the steering program. A camera, for example, is used to detect a transition between the field and the headland or to estimate the distance to an obstacle.

Depending on the scope of the geographical data accessed thereby, the satellite navigation device enables detecting diverse locations, such as boundaries between a field and a headland, or between fields having solid ground and fields having soft ground.

A transition between solid ground and soft ground can always be assumed in the case, for example, when the vehicle leaves a paved road that is loaded in the geographical data of the navigation device or returns thereto. Such a transition also can be assumed in the event of a change between dry and moist regions of an agricultural area, provided the information related thereto is contained in the geographical data.

Another vehicle may be considered to be a moving obstacle for inventive operation, in the vicinity of which a different steering program is used. The V2V wireless interface simplifies the detection of a vehicle that is adjacent to the vehicle configured according to the invention and with which coordination shall be implemented.

In an application, the steering control unit switches to a steering program in which the front and rear wheels pivot in opposite directions, in particular, upon transition from a field to a headland when the vehicle is leaving the field and reaches the boundary of the headland. This makes it possible to turn in a small space while minimizing grinding by the wheels. As such, the topsoil of the headland is not damaged when traveled over. Advantageously, a switch back to the previously used steering program occurs upon return to the field, wherein, depending on the type of vehicle and the ground conditions of the field, this steering program switch to Upon reentry to the field) is a steering program having front steering, a steering, program having rear steering, a steering program in which the front wheels and rear wheels pivot in the same direction, or a crab-steering program.

In the event of a transition from solid ground to soft ground, a switch to a crab-steering program is advantageously implemented in order to protect the ground.

In an application, upon the approach to a second vehicle, the steering control unit switches to a steering program in which the front wheels and rear wheels pivot in the same direction. Such a steering program makes it easier, in particular, to approach the second vehicle during travel in parallel. Therefore, the switch to the steering program in which the front wheels and rear wheels pivot in the same direction also is limited to the case in which the other vehicle travels on the same track or an adjacent track in the same direction as the vehicle having the steering control unit.

### BRIEF DESCRIPTION OF THE DRAWINGS

Further features and advantages of the invention will become apparent from the description of exemplary embodiments that follows, with reference to the attached figures, wherein:

FIG. 1 depicts a schematic top view of a vehicle configured according to the invention;

FIG. 2 depicts a schematic top view of a vehicle at work on a field according to one embodiment of the invention;

FIG. 3 depicts a schematic top view of a vehicle at work on a field according to another embodiment of the invention;

FIG. 4 depicts a schematic top view of a vehicle at work on a field according to yet another embodiment of the invention;

FIG. 5 depicts a schematic top view of a vehicle at work on a field according to still another embodiment of the invention.

### DETAILED DESCRIPTION OF THE INVENTION

The following is a detailed description of example embodiments of the invention depicted in the accompanying drawings. The example embodiments are presented in such detail as to clearly communicate the invention and are designed to make such embodiments obvious to a person of ordinary skill in the art. However, the amount of detail offered is not intended to limit the anticipated variations of embodiments; on the contrary, the intention is to cover all modifications, equivalents, and alternatives falling within the spirit and scope of the present invention, as defined by the appended claims.

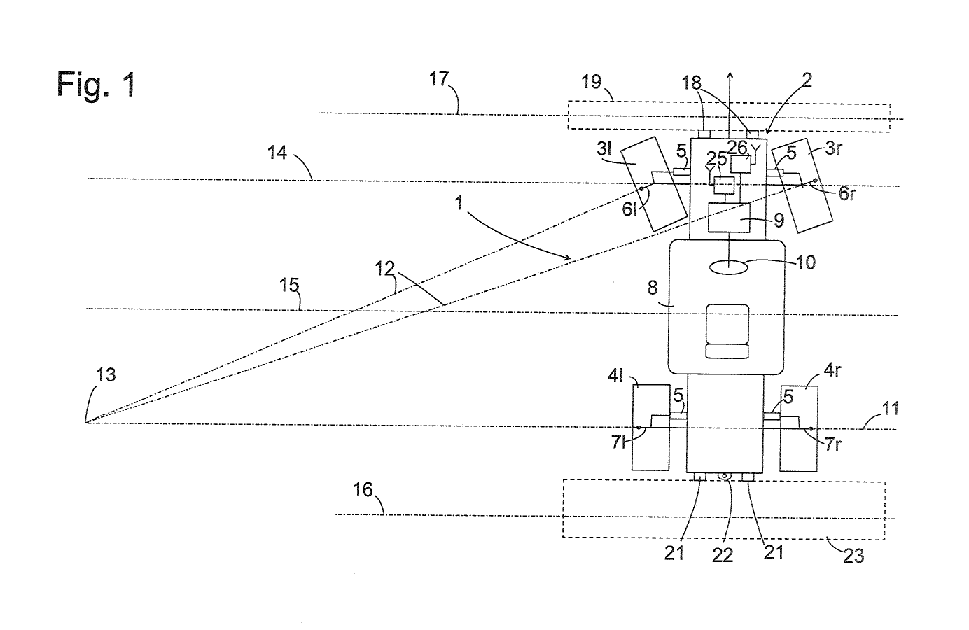

FIG. 1 shows a first embodiment of a vehicle according to the invention. That is, FIG. 1 shows a tractor 1 a highly schematic top view that comprises a chassis 2 having front wheels 3l, 3r and rear wheels 4l, 4r, which can pivot independently of one another about a vertical axis. The front and rear wheels 3l, 3r, 4l, 4r comprise stub axles 6l, 6r, 7l, 7r, respectively, which can pivot independently of one another, e.g. by a dedicated adjusting cylinder 5 in each case. A driver's cab is labelled with reference numeral 8. A steering control unit 9 determines the pivoting angle of the wheels 3l, 3r, 4l, 4r on the basis of direction-of-travel information, which, in this case, is derived from the position of a steering wheel 10 in the driver's cab 8. Alternatively, the direction-of-travel information is derived from the position of a control stick or could be provided by an autopilot, for example, on the basis of radio navigation signals or remote-control signals.

The steering control unit 9 supports a plurality of steering programs. When a front steering program is currently selected, i.e., the rear wheels 4l, 4r are unsteered and the stub axles 7l, 7r thereof extend along a straight rear chassis axis 11, while the front wheels 3l, 3r pivot about the vertical axis in accordance with the direction-of-travel information. As such, the instantaneous rotational axes 12 extending from the stub axles 6l, 6r thereof intersect the rear chassis axis 11 at a steering pole 13. The steering pole 13 moves along the rear chassis axis 11 to the right or left of the chassis 2 depending on the direction-of-travel information or the magnitude and direction of the steering angle.

In a rear steering program, which is also supported by the steering control unit 9, the front wheels 3l, 3r are unsteered and the stub axles 6l, 6r thereof extend along a straight front chassis axis 14. Concurrently, the rear wheels 4l, 4r are pivoted by the steering control unit 9 depending on the direction-of-travel information. In this program, a steering pole, at which the instantaneous rotational axes of the wheels 3l, 3r, 4l, 4r intersect, can move along the front chassis axis 14.

In addition, at least one steering program is supported in which the front and rear wheels 3, 4, respectively, pivot in opposite directions in accordance with the direction-of-travel information. If the steering angles of the front and rear wheels 3, 4, respectively, are the same but opposed, the steering pole moves along a line 15 that extends in the center between the front chassis axis 14 and the rear chassis axis 11.

Moreover, various steering programs are supported in which the front and rear wheels 3l, 3r, 4l, 4r all pivot in the same direction. In one of these programs, all wheels 3l, 3r, 4l, 4r pivot about the same angle. The instantaneous rotational axes thereof are therefore always parallel, and a steering pole is located in infinity. This steering program is suitable, in particular, for precisely controlling the position of the vehicle transversely to the track thereof when traveling along a predefined track.

There are other steering programs in which the front and rear wheels 3l, 3r, 4l, 4r pivot in the same direction, although the pivoting angles of the front wheels and the rear wheels are different. If the pivoting angle of the front wheels 3l, 3r is greater than that of the rear wheels 4l, 4r, a steering pole forms behind the rear chassis axis 11. If the rear wheels 4l, 4r pivot to a greater extent than the front wheels, the steering pole is located in front of the front chassis axis 14. Curves along which the steering pole can move in these two steering programs are indicated by lines 16 and 17 in FIG. 1. It is not necessary, however, for all the steering poles that can be obtained in a given steering program to lie on a straight line. The steering poles also can lie on curved lines, depending on how the pivoting angles of the front and rear wheels are linked to one another in the steering control unit 9 for a given steering program. The distance of the steering poles from the chassis axes 11 and 14 can be arbitrarily selected.

Further steering programs result from the combination of the above-described programs with crab steering. During straight-ahead travel, the stub axles of the front wheels 3l, 3r and the rear wheels 4l, 4r are normally located on a straight line, namely the front and rear chassis axis 14 and 11, respectively. But, during straight-ahead travel with crab steering, all wheels are pivoted in the same direction and by the same angle relative to the chassis axis thereof, wherein this crab-steering angle is selected such that the tracks of all wheels are laterally offset relative to one another. Travel around curves with crab steering is possible with front steering, rear steering, and with the front and rear wheels 3l, 3r, 4l, 4r pivoted in the same direction or in opposite directions.

The chassis 2 is provided with a coupling 18 on the front end thereof, at which various types of front-mounted tools 19, such as a cutter bar, can be mounted. In a similar manner, couplings 21, 22 for a tool 23 or a trailer are provided at the rear of the chassis 2. Tools for soil management, in particular, such as a harrow, are mounted at the rear of the tractor 1 via the coupling 21.

Different steering programs for fieldwork are advantageous depending on the type and installation position of the tool 19 or 23. The front-mounted tool 19 is best supported by the rear steering program or a steering program in which the wheels 3l, 3r, 4l, 4r pivot in the same direction and the steering poles are located in front of the front chassis axis 14, as indicated by the straight line 17. Given that the straight line 17 of the steering poles extends through the tool 19 or even lies in front thereof, the tool 19 does not swivel into the inside of the curve upon travel around a curve. This makes it possible, in the event that an obstacle must be driven around with close clearance, to prevent the tool 19 from swinging in the direction of the obstacle and colliding therewith.

If a rear-mounted soil-management tool such as the tool 23 swings out to the side during travel around a curve, considerable lateral forces occur between the tool 23 and the tractor 1, which could cause damage. Such lateral forces are limited or prevented by the use of the front steering program or a steering program having steering poles that form a curve extending behind the rear chassis axis 11 and preferably extending through the tool 23, namely, the straight line 16 in the case shown.

The steering control unit 9 receives information that is relevant to the selection of a steering program from a navigation device 25 and/or a V2V wireless interface 26. The navigation device 25 calculates, in a manner known per se, the geographical position of the tractor 1 on the basis of satellite radio signals such as GPS signals. On basis of the thusly calculated position, the navigation device determines information related to the surroundings in which the tractor 1 is located at the moment, from a data base that is carried along. This data base preferably contains information on the position and shape of agricultural areas to be worked, the ground condition thereof, the topography thereof, etc.

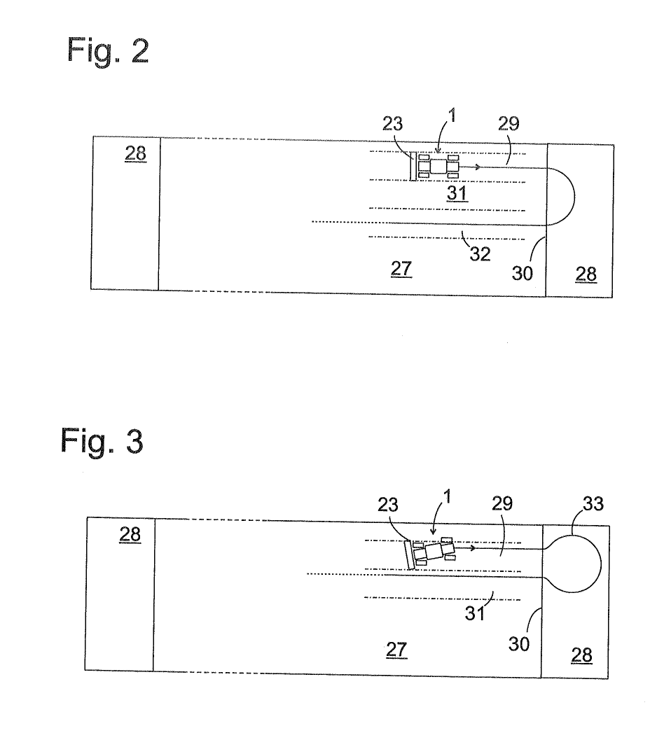

FIG. 2, which depicts the tractor 1 at work on the field in a schematic top view. In the tractor 1, the navigation device 25 of the steering control unit 9 provides information related, in particular, to whether the tractor 1 is located on a field 27 to be worked or on a headland 28 adjacent to the field 27. Provided that the tractor 1 is located on the field 27, for example, on a straight-line track 29, minor corrections of the position of the tractor 1 transversely to the direction of travel may be required, but extreme changes in direction will not be required. It is therefore possible, for example, to select the front steering program or, with consideration for the rear-mounted tool 23, the steering program that results in the steering pole line 17 extending through the tool 23 and behind the tractor 1.

If the tractor 1 has arrived at the boundary 30 of the headland 28, the navigation device 25 sends a message to this effect to the steering control unit 9. In order to allow turning in a small space, the steering control unit 9 switches to the steering program in which the front and rear wheels pivot in the same direction and simultaneously controls the raising of the tool 23 into a position disengaged from the ground. After the headland 28 has been passed through, the navigation device 25 signals that the boundary 30 has been reached once more and the steering control unit 9 switches back to the steering program used in the track 29 and lowers the tool 23 once more.

Although pivoting the front and rear wheels in opposite directions makes a narrow turning circle possible, the radius of such a turning circle is generally markedly greater than the width of the tool 23. At least one track 31 that must be worked in a second pass is located between the track 29 and a track 32 that is traveled once turning is completed. It is not possible to travel along tracks that are directly adjacent to one another on the field 27, such as tracks 29 and 31, without traveling in the headland 28 in a manner that is harsh on the ground.

In the potential application depicted in FIG. 3, the tractor 1 moves with crab steering while approaching the boundary 30 from the field 27, on a track 29. The longitudinal direction of the chassis 2 is deflected laterally relative to the direction of the track 29, namely to the left relative to the direction of travel in this case. The crab steering program is used continuously here on the entire field 27, from one headland 28 to the other. It also is feasible, however, to use a steering program in a central region of the field in which the rear wheels 4l, 4r run in the same tracks as the front wheels 3l, 3r, and the navigation device 25 generates a message to the steering control unit 9 at a predefined distance before the boundary 30 is reached. The message triggers the steering control unit 9 to switch from this steering program to the crab steering program.

A message from the steering control unit 9 that indicates that the boundary 30 has been reached initially induces all wheels to pivot in an orientation that is parallel to the chassis 2.

As a result,the direction of travel coincides with the longitudinal direction of the chassis once more, and the tractor 1 shifts from the direction of travel of the track 29 to the left. Finally, the steering control unit 9 switches to a steering program in which the wheels 3l, 3r and 4l, 4r pivot in opposite directions, in order to travel around a Ω-shaped curve 33 having a narrow radius. When the tractor, coming from the headland 28, reaches the boundary 30 once more, the above-described switchovers are implemented in the reverse direction. Therefore, travel takes place on the subsequent track 31 with crab steering once more. The track 31 is directly adjacent to the previously traveled track 29; no area between the tracks is left unworked and there was no need to drive back and forth on the headland 28.

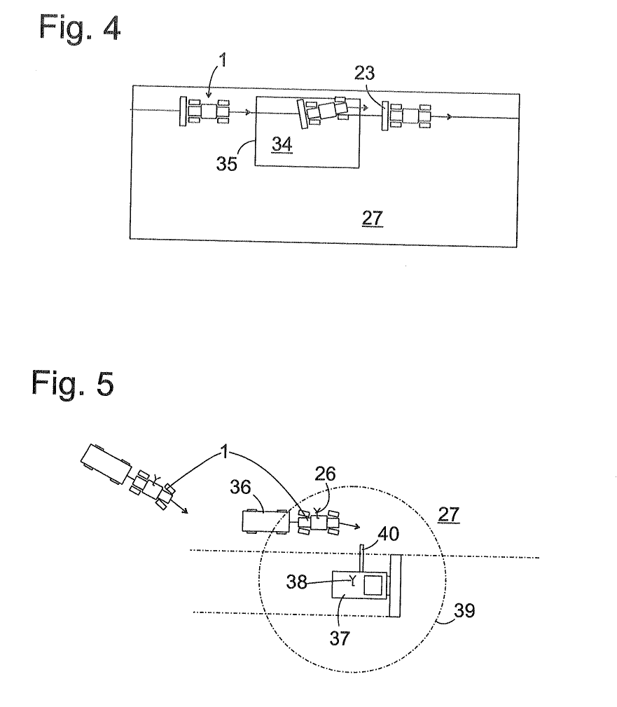

FIG. 4 highlights operation in a case in which a field section 34 has properties that deviate from the rest of the field 27, for example, where the field section 34 is a low-lying area in which the ground is damper and is softer than on the remaining field 27. If the navigation device 25 of the steering control unit 9 signals that a boundary 35 of this field section 34 has been reached, the steering control unit 9 reacts by briefly driving around a curve in order to orient the chassis 2 at a slant relative to the previous direction of travel, but to not displace the tool 23 laterally. The steering control unit then switches to a crab steering program in order to continue traveling while maintaining the original direction of travel although with the chassis 2 oriented at a slant relative to the direction of travel. Therefore, the tracks of the wheels 3, 4 are offset relative to one another and the load on the ground by the weight of the tractor 1 in the field section 32 is distributed over the largest possible area. The change is undone once the field section 34 is exited.

Conversely, an application also is feasible in which the tractor 1 travels with crab steering on a predominant portion of the field, in order to protect the ground, but the field has a slanted section which, in order to be overcome at least when traveling uphill, necessitates a switch into a steering program in which the rear wheels 4l, 4r run in the tracks of the front wheels 3l, 3r. Doing so enables these rear wheels to obtain greater traction on the ground that has been compacted by the front wheels. This switch also is automatically triggered every time a boundary is reached, at the base of the slanted section, on the basis of a message from the navigation device 25, and can be undone at the peak of the slanted section.

FIG. 5 shows another potential application, in which the tractor 1 is underway on a field 27 with a trailer 36 attached to the coupling 22 of this tractor, in order to receive the load from a combine harvester 37. As shown, the combine harvester 37 is simultaneously harvesting the area 27. The combine harvester 37 has a V2V wireless interface 38, which is compatible with the wireless interface 26 of the tractor 1. On the basis of information delivered by the navigation device 25 related to its own position and position information related to the combine harvester 37 received via the wireless interfaces 26, 38, the steering control unit 9 determines the side of the boundary 40 of a close range 39 of the combine harvester 37 on which the tractor 1 is located.

As an alternative, such a decision can be made without accessing position information on the basis of the intensity of a radio signal received by the wireless interface 26, on the basis of images from a camera that is mounted on-board the tractor 1 or the combine harvester 37 and monitors the particular close range. Outside of the close range 39, the steering control unit 9 as shown, utilizes the front steering program or a steering program in which the front wheels and rear wheels pivot in the same direction, in which the steering, pole is located behind the rear chassis axis 11 of the tractor 1. Such operation makes it possible to travel around tight curves, if necessary, and to permit extreme changes in direction.

Upon entry into the close range 39, the steering control unit 9 switches to a steering program in which all wheels 3l, 3r, 4l, 4r pivot in the same direction, in order to permit an approach to the combine harvester 37 and minimize the tendency of the trailer 36 to swing out too far when the direction of travel of the tractor 1 changes. It is therefore possible to position the trailer 36 underneath an upper discharge chute 41 of the combine harvester 37 such that the loading, surface of the trailer 36 is impacted by transferred crop exactly at an intended point. Once the transfer procedure has ended and the tractor 1 leaves the close range 39 once more, the steering control unit 9 switches back to the previously used steering program.

In order to reduce the likelihood that the tractor 1 and the combine harvester 37 will influence each other in the event of an accidental approach, the invention provides a mode by which the steering program does not automatically switch every time the tractor 1 enters or exits the close range 39. Instead, upon entry into the close range 39, the directions of travel of the tractor 1 and the combine harvester 37 are compared and a switch is implemented only if these correspond to the extent that a direction of travel by the tractor 1 that is exactly parallel to the combine harvester 37 can be achieved without the need to exit the close range 39 in the meantime.

### REFERENCE CHARACTERS

1 tractor

2 chassis

3l, 3r front wheel

4l, 4r rear wheel

5 adjusting cylinder

6l, 6r stub axle

7l, 7r stub axle

8 driver's cab

9 steering control unit

10 steering wheel

11 rear chassis axis

12 instantaneous rotational axis

13 steering pole

14 axis

15 steering pole line

16 steering pole line

17 steering pole line

18 coupling

19 tool

21 coupling

22 coupling

23 tool

25 navigation device

26 wireless interface

27 field

28 headland

29 track

30 boundary

31 track

32 track

33 curve

34 field section

36 trailer

37 combine harvester

38 wireless interface

39 close range

40 boundary

41 upper discharge chute

As will be evident to persons skilled in the art, the foregoing detailed description and figures are presented as examples of the invention, and that variations are contemplated that do not depart from the fair scope of the teachings and descriptions set forth in this disclosure. The foregoing is not intended to limit what has been invented, except to the extent that the following claims so limit that.

What is claimed is:

1. An agricultural vehicle, comprising:
steerable front and rear wheels; and
a steering control unit for controlling a steering pole of the wheels on a basis of direction-of-travel information;
wherein this steering control unit is configured to switch between two or more steering programs that respectively implement different interrelationships between the direction-of-travel information and the steering pole; and
wherein the steering control unit switches between the two or more steering programs in an event-dependent manner.

2. The vehicle according to claim 1, wherein the two or more steering programs are selected from a group of steering programs consisting of: a front steering program, a rear steering program, an all-wheel steering program in which the front and rear wheels pivot in the same direction, embodying crab steering, and an all-wheel steering program in which the front and rear wheels pivot in opposite directions.

3. The vehicle according to claim 1, wherein an arrival of the vehicle at a location is an event that prompts the steering program to be switched.

4. The vehicle according to claim 3, wherein the location is a boundary of a field or the surroundings of a fixed or moving obstacle.

5. The vehicle according to claim 1, wherein the vehicle comprises a device for detecting an event selected from a group consisting of: a camera, a satellite navigation device, a V2V wireless interface and a combination thereof.

6. The vehicle according to claim 1, wherein in the event of a transition from a field to a headland, the steering control unit switches to all-wheel steering in which the front and rear wheels pivot in opposite directions.

7. The vehicle according to claim 2, wherein the steering control unit switches to crab steering upon transition from solid to soft ground.

8. The vehicle according to claim 1, wherein upon reaching the surroundings of a second vehicle, the steering control unit switches to all-wheel steering in which the front and rear wheels pivot in the same direction.

9. The vehicle according to claim 8, wherein the steering control unit switches to all-wheel steering with pivoting in the same direction only when the other vehicle travels in the same direction on the same track as the vehicle or on an adjacent track.
